(19) United States
(12) Patent Application Publication
(10) Pub. No.: US 2013/0146545 A1
(43) Pub. Date: Jun. 13, 2013

(54) USE OF ECO-FRIENDLY MICROEMULSIONS IN OIL CLEANING APPLICATIONS

(71) Applicants: Ruela Talingting Pabalan, Burlington, NJ (US); Charles Aymes, Monmouth Junction, NJ (US); Stephen Graham, Bensalem, PA (US); Amit Sehgal, Marlton, NJ (US); Satyen Trivedi, East Windsor, NJ (US); David Fluck, Elkton, MD (US); Bruno Langlois, Paris (FR)

(72) Inventors: Ruela Talingting Pabalan, Burlington, NJ (US); Charles Aymes, Monmouth Junction, NJ (US); Stephen Graham, Bensalem, PA (US); Amit Sehgal, Marlton, NJ (US); Satyen Trivedi, East Windsor, NJ (US); David Fluck, Elkton, MD (US); Bruno Langlois, Paris (FR)

(73) Assignee: RHODIA OPERATIONS, Aubervilliers (FR)

(21) Appl. No.: 13/701,657

(22) PCT Filed: Jun. 2, 2011
(86) PCT No.: PCT/US11/01000

§ 371 Date: Feb. 26, 2013

Related U.S. Application Data
(60) Provisional application No. 61/396,716, filed on Jun. 2, 2010.

(51) Int. Cl. C11D 3/20

(52) U.S. Cl. CPC C11D 3/2068; C11D 3/2093
USPC 210/698; 510/365

(57) ABSTRACT

An environmentally-friendly cleaning composition for oil cleaning comprising (a) a blend of dibasic esters, (b) one or more surfactants (c) and, optionally, (d) water or a solvent. The dibasic esters are be derived from a blend of adipic, glutaric, and succinic diacids, and, in one particular embodiment, the blend comprises dialkyl adipate, dialkyl methylglutarate and dialkyl ethylsuccinate, wherein the alkyl groups individually comprise a C₁-C₁₂ hydrocarbon group. The one or more surfactants are typically chosen from alcohol alkoxylate, an alkyl phenol ethoxylate, a terpene, a terpene alkoxylate or any derivates thereof. Optionally, additional components or additives including delaminates such as pinene and d-limonene, fragrances, whiteners, stabilizers, thickeners and the like can be added to the composition.

### CROSS-REFERENCE TO RELATED APPLICATIONS

The application is a continuation-in-part application of U.S. application Ser. No. 12/387,887, filed May 8, 2009, and claims the benefit of U.S. Provisional Application Ser. No. 61/396,716, filed Jun. 2, 2010, all of which are hereby incorporated by reference.

### FIELD OF THE INVENTION

This invention relates to cleaning compositions that are environmentally friendly, biodegradable, non-toxic and non-flammable with low odor, low vapor pressure and low volatile organic compound (VOC) content and, more particularly, cleaning compositions utilized to clean oils spills off shore, on shore and inland, as well as substrates covered from such oil and the like.

### BACKGROUND OF THE INVENTION

Oil spills and slicks are a significant problem for communities and businesses exposed to oil contamination, as well environmental hazards including toxic exposure to birds and animals. There are current solutions in off shore oil spills, for example the use of oil dispersants. Oil dispersants are proprietary blends of surfactants, solvents and water. They are able to emulsify oil in the waters thereby making the oil readily oxidizable by enzymes and the natural oxidizers. For surface washing, other blends are also commercially available. They can wash oil from surfaces after applying them on the contaminated substrates. However, such solutions have significant drawbacks as such dispersants pose problems to the environment and are not readily biodegradable.

### SUMMARY OF THE INVENTION

The present invention will become apparent from the following detailed description and examples, which comprises in one aspect, is a cleaning composition comprising one or more dibasic esters; one or more surfactants; and, optionally, additional components and/or water. In one embodiment, the cleaning composition is capable of cleaning oil from a leak or spill. The spilled oil can be cleaned from a surface or object such as rocks, sand, mammals such as birds, humans, reptiles, etc., plants, trees, and the like. In another embodiment, the cleaning composition is capable of being an oil dispersant that is sprayed or contacted with an oil leak, spill or slick.

The dibasic esters can be derived from adipic, glutaric, and succinic diacids, or isomers thereof. In one particular embodiment, the dibasic ester blend is comprised of a mixture dialkyl methylglutarate, dialkyl ethylsuccinate and dialkyl adipate, where the alkyl groups individually comprise C₁-C₁₂ hydrocarbon groups.

In one aspect, the present invention is a cleaning composition comprising (a) a blend of dibasic esters comprising at least two of dialkyl adipate, dialkyl methylglutarate, dialkyl ethylsuccinate, dialkyl glutarate and dialkyl succinate, typically (i) a mixture of dialkyl methylglutarate, dialkyl ethylsuccinate and, optionally, dialkyl adipate, or (ii) a mixture of dialkyl adipate, dialkyl glutarate and dialkyl succinate, where the alkyl groups individually comprise C₁-C₁₂ hydrocarbon groups; and (b) a surfactant selected from the group consisting of an anionic surfactant, a cationic surfactant, an amphoteric surfactant, a zwitterionic surfactant, a nonionic surfactant and any combination thereof.

The cleaning composition of the present invention has desirable qualities including one or a combination of being: substantially non-toxic, non-flammable, readily biodegradable, high flash point, low vapor pressure and low odor; meets the consumer products LVP-VOC exemption criteria established by CARB and the EPA (certain sections). In one embodiment, the vapor pressure of the cleaning composition is less than or equal to 0.5 mmHg @ 20° C. In another embodiment, the vapor pressure of the cleaning composition is less than or equal to 0.1 mmHg @ 20° C. In a further embodiment, the vapor pressure of the cleaning composition is less than or equal to 0.2 mmHg @ 20° C. In yet a further embodiment, the vapor pressure of the cleaning composition is less than or equal to 0.01 mmHg @ 20° C.

In another aspect, the present invention is a cleaning composition comprising, based on the total weight of the composition, (a) from about 1% to about 60% by weight a blend of dibasic esters; (b) from about 0.1% to about 65% by weight one or more surfactants; and optionally, (c) water. In another embodiment, the cleaning composition further comprises about 1% to about 12% by weight d-limonene. The cleaning composition of the present invention can be used in a variety of consumer and/or industrial applications, but typically is used in the present invention to clean or disperse oil slicks, oil leaks and oil spills. Such oil may be in contact with or may undesirably coat objects such as rocks, sands, mammals, birds, plants, etc.

In another aspect, the present invention is a cleaning composition in the form of a microemulsion comprising: from about 1% to about 60% by weight a blend of dibasic esters; from about 0.1% to about 65% by weight one or more surfactants; and, optionally, water; more typically, from about 5% to about 40% by weight a blend of dibasic esters; (b) from about 5% to about 40% by weight one or more surfactants, typically, one or more nonionic surfactants; and, optionally, (c) water. In another embodiment, the cleaning composition microemulsion further comprises about 1% to about 12% by weight a terpene, terpene EO/PO, pinene or derivative thereof. Optionally, additives such as fragrances and solubilizers, pH adjusting agents, whiteners, delaminates, opacifying agent, anti-corrosion agents, anti-foaming agents, coloring agents, stabilizers and thickeners can be added. The cleaning composition of the present invention is typically in form of a microemulsion and provided as a liquid or spray formulation for use, depending upon the application.

The surfactant can be any number of amphoteric, cationic, anionic or nonionic surfactants or a blend of surfactants. In one embodiment, the surfactant a nonionic surfactant, typically, an alcohol ethoxylate, an alkyl phenol ethoxylate or a terpene alkoxylate. More typically, the surfactant is a C₇-C₁₂ alcohol ethoxylate, e.g., Rhodasurf 91-6 surfactant manufactured by Rhodia Inc. (Cranbury, N.J.), and most typically, the surfactant is a C₉-C₁₁ linear alcohol ethoxylate.

In a further aspect, the present invention is an industrial and/or consumer cleaning composition comprising: (a) from about 1% to about 65%, by weight of the cleaning composition, a blend of dibasic esters, wherein the blend comprises:

(i) about 7-14%, by weight of the blend, a diester of formula:

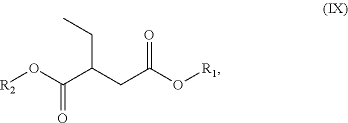

(ii) about 80-94%, by weight of the blend, a diester of formula

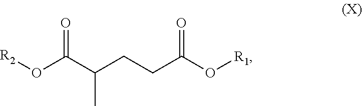

and

(iii) about 0-5% (by weight of the blend) a diester of formula

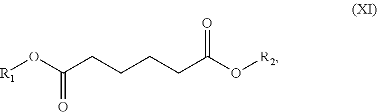

wherein R₁ and/or R₂ individually comprise a hydrocarbon having from about 1 to about 12 carbon atoms, typically, methyl, ethyl, propyl, isopropyl, butyl, isobutyl, n-butyl or isoamyl; (b) from about 0.1% to about 65%, by weight of the cleaning composition, a surfactant; (c) from about 0% to about 12%, by weight of the cleaning composition, one or more additional components, and (d) from about 2% to about 85%, by weight of the cleaning composition, water.

In another aspect, the invention is a method of cleaning a oil coated surface comprising: (a) obtaining a cleaning composition comprising: (i) a blend of dibasic esters comprising dialkyl adipate, dialkyl methylglutarate and dialkyl ethylsuccinate; and (ii) a surfactant selected from the group consisting of an anionic surfactant, a cationic surfactant, an amphoteric surfactant, a zwitterionic surfactant, a nonionic surfactant and any combination thereof; (b) contacting the cleaning composition with a coated surface having a stain on said surface; and (c) removing the used cleaning composition from the cleaned coated surface.

The cleaning composition of the present invention is environmentally friendly, with a high flash point, low vapor pressure and low odor; it falls under the consumer products LVP-VOC exemption criteria established by CARB and the EPA (certain sections). The cleaning formulation of the present invention has environmentally friendly characteristics including but not limited to being non toxic, bio-degradable, non-flammable and the like.

### DETAILED DESCRIPTION

As used herein, the term “alkyl” means a saturated or unsaturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cᵣ—Cₛ)” in reference to an organic group, wherein r and s are each integers, indicates that the group may contain from r carbon atoms to s carbon atoms per group.

As used herein, the terminology “surfactant” means a compound that when dissolved in an aqueous medium lowers the surface tension of the aqueous medium.

The present invention is a cleaning composition comprising a blend of dibasic esters. In one embodiment, the blend comprises a mixture of adducts of alcohol and linear diacids, the adducts having the formula R₁—OOC-A-COO—R₂ wherein R₁ and/or R₂ comprise, individually, a C₁-C₁₂ alkyl, more typically a C₁-C₈ alkyl, and A comprises a —(CH₂)₄—, —(CH₂)₃, or —(CH₂)₂—. In another embodiment, R₁ and/or R₂ comprise, individually, a C₄-C₁₂ alkyl, more typically a C₄-C₈ alkyl. In one embodiment, R₁ and R₂ can individually comprise a hydrocarbon group originating from fusel oil. In one embodiment, R₁ and R₂ individually can comprise a hydrocarbon group having 1 to 8 carbon atoms. In one embodiment, R₁ and R₂ individually can comprise a hydrocarbon group having 5 to 8 carbon atoms.

In one embodiment, the blend comprises a mixture of adducts of alcohol and branched or linear diacids, the adducts having the formula R1-OOC-A-COO—R2 wherein R1 and/or R2 comprise, individually, a C1-C12 alkyl, more typically a C1-C8 alkyl, and A comprises—(CH2)4—, —CH2CH2CH(CH3)-, or —CH2CH(C2H5)-. In another embodiment, R1 and/or R2 comprise, individually, a C4-C12 alkyl, more typically a C4-C8 alkyl. In one particular embodiment, the blend comprises a mixture of adducts having formulas R1-OOC—CH2CH2CH(CH3)-COO—R2 and R1-OOC—CH2CH(C2H5)-COO—R2. It is understood that the acid portion may be derived from such dibasic acids such as adipic, succinic, glutaric, oxalic, malonic, pimelic, suberic and azelaic acids, as well as mixtures thereof.

One or more dibasic esters used in the present invention can be prepared by any appropriate process. For example, a process for preparing the adduct of adipic acid and of fusel oil is, for example, described in the document “The Use of Egyptian Fusel Oil for the Preparation of Some Plasticizers Compatible with Polyvinyl Chloride”, Chuiba et al., Indian Journal of Technology, Vol. 23, August 1985, pp. 309-311.

The dibasic esters of the present invention can be obtained by a process comprising an “esterification” stage by reaction of a diacid of formula HOOC-A-COOH or of a diester of formula MeOOC-A-COOMe with a branched alcohol or a mixture of alcohols. The reactions can be appropriately catalyzed. Use is preferably made of at least 2 molar equivalents of alcohols per diacid or diester. The reactions can, if appropriate, be promoted by extraction of the reaction by-products and followed by stages of filtration and/or of purification, for example by distillation.

The diacids in the form of mixtures can in particular be obtained from a mixture of dinitrile compounds in particular produced and recovered in the process for the manufacture of adiponitrile by double hydrocyanation of butadiene. This process, used on a large scale industrially to produce the greater majority of the adiponitrile consumed worldwide, is described in numerous patents and works. The reaction for the hydrocyanation of butadiene results predominantly in the formulation of linear dinitriles but also in formation of branched dinitriles, the two main ones of which are methylglutaronitrile and ethylsuccinonitrile. The branched dinitrile compounds are separated by distillation and recovered, for example, as top fraction in a distillation column, in the stages for separation and purification of the adiponitrile. The branched dinitriles can subsequently be converted to diacids or diesters (either to light diesters, for a subsequent transesterification reaction with the alcohol or the mixture of alcohols or the fusel oil, or directly to diesters in accordance with the invention).

Dibasic esters of the present invention may be derived from one or more by-products in the production of polyamide, for example, polyamide 6,6. In one embodiment, the cleaning composition comprises a blend of linear or branched, cyclic or noncyclic, C₁-C₂₀ alkyl, aryl, alkylaryl or arylalkyl esters of adipic diacids, glutaric diacids, and succinic diacids. In another embodiment, the cleaning composition comprises a blend of linear or branched, cyclic or noncyclic, C₁-C₂₀ alkyl, aryl, alkylaryl or arylalkyl esters of adipic diacids, methylglutaric diacids, and ethylsuccinic diacids

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend of the present invention can be derived from one or more by-products in the reaction, synthesis and/or production of adipic acid utilized in the production of polyamide, the cleaning composition comprising a blend of dialkyl esters of adipic diacids, glutaric diacids, and succinic diacids (herein referred to sometimes as “AGS” or the “AGS blend”).

In one embodiment, the blend of esters is derived from by-products in the reaction, synthesis and/or production of hexamethylenediamine utilized in the production of polyamide, typically polyamide 6,6. The cleaning composition comprises a blend of dialkyl esters of adipic diacids, methylglutaric diacids, and ethylsuccinic diacids (herein referred to sometimes as “MGA”, “MGN”, “MGN blend” or “MGA blend”).

The boiling point of the dibasic ester blend of the present invention is between the range of about 120° C. to 450° C. In one embodiment, the boiling point of the blend of the present invention is in the range of about 160° C. to 400° C.; in one embodiment, the range is about 210° C. to 290° C.; in another embodiment, the range is about 210° C. to 245° C.; in another embodiment, the range is the range is about 215° C. to 225° C. In one embodiment, the boiling point range of the blend of the present invention is between about 210° C. to 390° C., more typically in the range of about 280° C. to 390° C., more typically in the range of 295° C. to 390° C. In one embodiment, boiling point of the blend of the present invention is in the range of about 215° C. to 400° C., typically in the range of about 220° C. to 350° C.

In one embodiment, the blend of dibasic esters has a boiling point range of between about 300° C. and 330° C. Typically, the diisoamyl AGS blend is associated with this boiling point range. In another embodiment, the dibasic ester blend of the present invention has a boiling point range of between about 295° C. and 310° C. Typically, the di-n-butyl AGS blend is associated with this boiling point range. Generally, a higher boiling point, typically, above 215° C., or high boiling point range corresponds to lower VOC.

The dibasic esters or blend of dibasic esters are incorporated into a cleaning composition of the present invention which, in one embodiment, comprises (a) a blend of dialkyl esters of adipic, glutaric, and succinic diacids or a blend of dialkyl esters of adipic, methylglutaric, and ethylsuccinic diacids; (b) at least one surfactant; and, optionally, (c) water or a solvent. Additional components may be added. The surfactant can be any number of cationic, amphoteric, zwitterionic, anionic or nonionic surfactants, derivatives thereof, as well as blends of such surfactants.

In one embodiment, the nonionic surfactants generally includes one or more of for example amides such as alkanolamides, ethoxylated alkanolamides, ethylene bisamides; esters such as fatty acid esters, glycerol esters, ethoxylated fatty acid esters, sorbitan esters, ethoxylated sorbitan; ethoxylates such as alkylphenol ethoxylates, alcohol ethoxylates, tristyrylphenol ethoxylates, mercaptan ethoxylates; end-capped and EO/PO block copolymers such as ethylene oxide/propylene oxide block copolymers, chlorine capped ethoxylates, tetra-functional block copolymers; amine oxides such lauramine oxide, cocamine oxide, stearamine oxide, stearamidopropylamine oxide, palmitamidopropylamine oxide, decylamine oxide; fatty alcohols such as decyl alcohol, lauryl alcohol, tridecyl alcohol, myristyl alcohol, cetyl alcohol, stearyl alcohol, oleyl alcohol, linoleyl alcohol and linolenyl alcohol; and alkoxylated alcohols such as ethoxylated lauryl alcohol, trideceth alcohols; and fatty acids such as lauric acid, oleic acid, stearic acid, myristic acid, cetearic acid, isostearic acid, linoleic acid, linolenic acid, ricinoleic acid, elaidic acid, arichidonic acid, myristoleic acid and mixtures thereof.

In another embodiment, the non-ionic surfactant is a glycol such as polyethylene glycol (PEG), alkyl PEG esters, polypropylene glycol (PPG) and derivatives thereof. In one embodiment, the surfactant is an alcohol ethoxylate, an alkyl phenol ethoxylate or a terpene alkoxylate. In one exemplary embodiment, the surfactant is a C₆-C₁₃ alcohol ethoxylate and, more typically, a C₈-C₁₂ alcohol ethoxylate.

In another embodiment, the surfactant is a cationic surfactant. The cationic surfactant includes but is not limited to quaternary ammonium compounds, such as cetyl trimethyl ammonium bromide (also known as CETAB or cetrimonium bromide), cetyl trimethyl ammonium chloride (also known as cetrimonium chloride), myristyl trimethyl ammonium bromide (also known as myrtrimonium bromide or Quaternium-13), stearyl dimethyl distearyldimonium chloride, dicetyl dimonium chloride, stearyl octyldimonium methosulfate, dihydrogenated palmoylethyl hydroxyethylmonium methosulfate, isostearyl benzylimidonium chloride, cocoyl benzyl hydroxyethyl imidazolinium chloride, dicetyl dimonium chloride and distearyldimonium chloride; isostearylaminopropalkonium chloride or olealkonium chloride; behentrimonium chloride; as well as mixtures thereof.

In another embodiment, the surfactant is an anionic surfactant. The anionic surfactant includes but is not limited to linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, sulfosuccinates, isethionates, and taurates, as well as mixtures thereof. Commonly used anionic surfactants that are suitable as the anionic surfactant component of the composition of the present invention include, for example, ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium-monoalkyl phosphates, sodium dialkyl phosphates, sodium lauroyl sarcosinate, lauroyl sarcosine, cocoyl sarcosine, ammonium cocyl sulfate, ammonium lauryl sulfate, sodium cocyl sulfate, sodium trideceth sulfate, sodium tridecyl sulfate, ammonium trideceth sulfate, ammonium tridecyl sulfate, sodium cocoyl isethionate, disodium laureth sulfosuccinate, sodium methyl oleoyl taurate, sodium laureth carboxylate, sodium trideceth carboxylate, sodium lauryl sulfate, potassium cocyl sulfate, potassium lauryl sulfate, monoethanolamine cocyl sulfate, sodium tridecyl benzene sulfonate, and sodium dodecyl benzene sulfonate. Branched anionic surfactants are particularly preferred, such as sodium trideceth sulfate, sodium tridecyl sulfate, ammonium trideceth sulfate, ammonium tridecyl sulfate, and sodium trideceth carboxylate.

Any amphoteric surfactant that is acceptable for use includes but is not limited to derivatives of aliphatic secondary and tertiary amines in which the aliphatic radical can be straight chain or branched and wherein one of the aliphatic substituents contains from about 8 to about 18 carbon atoms and one contains an anionic water solubilizing group. Specific examples of suitable amphoteric surfactants include the alkali metal, alkaline earth metal, ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates, such as for example, cocoamphoacetate cocoamphopropionate, cocoamphodiacetate, lauroamphoacetate, lauroamphodiacetate, lauroamphodipropionate, lauroamphodiacetate, cocoamphopropyl sulfonate caproamphodiacetate, caproamphoacetate, caproamphodipropionate, and stearoamphoacetate.

Suitable zwitterionic surfactants include alkyl betaines, such as cocodimethyl carboxymethyl betaine, lauryl dimethyl carboxymethyl betaine, lauryl dimethyl alpha-carboxy-ethyl betaine, cetyl dimethyl carboxymethyl betaine, lauryl bis-(2-hydroxy-ethyl)carboxy methyl betaine, stearyl bis-(2-hydroxy-propyl)carboxymethyl betaine, oleyl dimethyl gamma-carboxypropyl betaine, and lauryl bis-(2-hydroxypropyl)alpha-carboxyethyl betaine, amidopropyl betaines, and alkyl sultaines, such as cocodimethyl sulfopropyl betaine, stearyldimethyl sulfopropyl betaine, lauryl dimethyl sulfoethyl betaine, lauryl bis-(2-hydroxy-ethyl)sulfopropyl betaine, and alkylamidopropylhydroxy sultaines.

In one embodiment, the cleaning composition is a microemulsion comprising (a) a blend of about 70-90% dialkyl dimethylglutarate, about 5-30% dialkyl ethylsuccinate and about 0-10% dialkyl adipate; (b) a surfactant composition comprising i) an alcohol alkoxylate, a terpene alkoxylate, or derivatives thereof; (c) a delaminate and (d) water. Each alkyl substituent individually chosen from a hydrocarbon group containing from about 1 to 8 hydrocarbons such as methyl or ethyl, propyl, isopropyl, butyl, n-butyl or pentyl, or iso-amyl groups. Optionally, one or more additives or additional components such as delaminating agents, buffering and/or pH control agents, fragrances, opacifying agents, anti-corrosion agents, whiteners, defoamers, dyes, sudsing control agents, stabilizers, thickeners and the like can be added to the composition.

According to one embodiment of the present invention, the blend of dibasic esters corresponds to one or more by-products of the preparation of adipic acid, which is one of the main monomers in polyamides. For example, the dialkyl esters are obtained by esterification of one by-product, which generally contains, on a weight basis, from 15 to 33% succinic acid, from 50 to 75% glutaric acid and from 5 to 30% adipic acid. As another example, the dialkyl esters are obtained by esterification of a second by-product, which generally contains, on a weight basis, from 30 to 95% methyl glutaric acid, from 5 to 20% ethyl succinic acid and from 1 to 10% adipic acid. It is understood that the acid portion may be derived from such dibasic acids such as, adipic, succinic, glutaric, oxalic, malonic, pimelic, suberic and azelaic acids, as well as mixtures thereof.

In some embodiments, the dibasic ester blend comprises adducts of alcohol and linear diacids, the adducts having the formula R—OOC-A-COO—R wherein R is ethyl and A is a mixture of —(CH₂)₄—, —(CH₂)₃, and —(CH₂)₂—. In other embodiments, the blend comprises adducts of alcohol, typically ethanol, and linear diacids, the adducts having the formula R¹—OOC-A-COO—R², wherein at least part of R¹ and/or R² are residues of at least one linear alcohol having 4 carbon atoms, and/or at least one linear or branched alcohol having at least 5 carbon atoms, and wherein A is a divalent linear hydrocarbon. In some embodiments A is one or a mixture of —(CH₂)₄—, —(CH₂)₃, and —(CH₂)₂—.

In another embodiment, the R¹ and/or R² groups can be linear or branched, cyclic or noncyclic, C₁-C₂₀ alkyl, aryl, alkylaryl or arylalkyl groups. Typically, the R¹ and/or R² groups can be C₁-C₈ groups, for example groups chosen from the methyl, ethyl, n-propyl, isopropyl, n-butyl, n-amyl, n-hexyl, cyclohexyl, 2-ethylhexyl and isooctyl groups and their mixtures. For example, R¹ and/or R² can both or individually be ethyl groups, R¹ and/or R² can both or individually be n-propyl groups, R¹ and/or R² can both or individually be isopropyl groups, R¹ and/or R² can both or individually be n-butyl groups, R¹ and/or R² can both or individually be iso-amyl groups, R¹ and/or R² can both or individually be n-amyl groups, or R¹ and/or R² can be mixtures thereof (e.g., when comprising a blend of dibasic esters).

In further embodiments the invention can include blends comprising adducts of branched diacids, the adducts having the formula R³OOC-A-COO—R⁴ wherein R³ and R⁴ are the same or different alkyl groups and A is a branched or linear hydrocarbon. Typically, A comprises an isomer of a C₄ hydrocarbon. Examples include those where R³ and/or R⁴ can be linear or branched, cyclic or noncyclic, C₁-C₂₀ alkyl, aryl, alkylaryl or arylalkyl groups. Typically, R³ and R⁴ are independently selected from the group consisting of methyl, ethyl, propyl, isopropyl, butyl, n-butyl, iso-butyl, iso-amyl, and fusel.

In yet another embodiment, the invention comprises a composition based on dicarboxylic acid diester(s) of formula R⁵—OOC-A-COO—R⁶ wherein group A represents a divalent alkylene group typically in the range of, on average, from 2.5 to 10 carbon atoms. R⁵ and R⁶ groups, which can be identical or different, represent a linear or branched, cyclic or noncyclic, C₁-C₂₀ alkyl, aryl, alkylaryl or an arylalkyl group.

The blend can correspond to a complex reaction product, where mixtures of reactants are used. For example, the reaction of a mixture of HOOC-A^{a}-COOH and HOOC-A^{b}-COOH with an alcohol R^{a}—OH can give a mixture of the products R^{a}OOC-A^{a}-COOR^{a} and R^{a}OOC-A^{b}-COOR^{a}. Likewise, the reaction of HOOC-A^{a}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b} and R^{b}OOC-A^{a}-COOR^{a} (different from R^{a}OOC-A^{a}-COOR^{b} if A^{a} is not symmetrical). Likewise, the reaction of a mixture of HOOC-A^{a}-COOH and HOOC-A^{b}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b}, R^{b}OOC-A^{a}-COOR^{a} (different from R^{a}OOC-A^{a}-COOR^{b} if A^{a} is not symmetrical), R^{a}OOC-A^{b}-COOR^{a} and R^{b}OOC-A^{b}-COOR^{b}, R^{a}OOC-A^{b}-COOR^{b} and R^{b}OOC-A^{b}-COOR^{a} (different from R^{a}OOC-A^{b}-COOR^{b} if A^{b} is not symmetrical).

The groups R¹ and R², can correspond to alcohols R¹—OH and R²—OH (respectively). These groups can be likened to the alcohols. The group(s) A, can correspond to one or more dicarboxylic acid(s) HOOC-A-COOH. The group(s) A can be likened to the corresponding diacid(s) (the diacid comprises 2 more carbon atoms than the group A).

In one embodiment, group A is a divalent alkylene group comprising, on average, more than 2 carbon atoms. It can be a single group, with an integral number of carbon atoms of greater than or equal to 3, for example equal to 3 or 4. Such a single group can correspond to the use of a single acid. Typically, however, it corresponds to a mixture of groups corresponding to a mixture of compounds, at least one of which exhibits at least 3 carbon atoms. It is understood that the mixtures of groups A can correspond to mixtures of different isomeric groups comprising an identical number of carbon atoms and/or of different groups comprising different numbers of carbon atoms. The group A can comprise linear and/or branched groups.

According to one embodiment, at least a portion of the groups A corresponds to a group of formula —(CH₂)ₙ— where n is a mean number greater than or equal to 3. At least a portion of the groups A can be groups of formula —(CH₂)₄— (the corresponding acid is adipic acid). For example, A can be a group of formula —(CH₂)₄—, and/or a group of formula —(CH₂)₃—.

In one embodiment, the composition comprises compounds of formula R—OOC-A-COO—R where A is a group of formula —(CH₂)₄—, compounds of formula R—OOC-A-COO—R where A is a group of formula —(CH₂)₃—, and compounds of formula R—OOC-A-COO—R where A is a group of formula —(CH₂)₂—.

The blend of dibasic esters is typically present in the cleaning composition in microemulsion form (liquid droplets dispersed in the aqueous phase). Without wishing to be bound to any theory, it is pointed out that microemulsions are generally thermodynamically stable systems generally comprising large amounts of emulsifiers. A microemulsion is not an emulsion, and is distinguishable from an emulsion in that the microemulsion is thermodynamically stable, which means it is at its lowest energy state. In comparison, n emulsion is only kinetically stable, which means the rate at which the emulsified phase is separating from the water is very slow. Microemulsion can be easily prepared by gentle mixing or shaking, and will not easily separate into separate phases or settle out.

The other emulsions (macroemulsions) are generally systems in thermodynamically unstable state, conserving for a certain time, in metastable state, the mechanical energy supplied during the emulsification. These systems generally comprise smaller amounts of emulsifiers.

In one embodiment, the microemulsion of the present invention is an emulsion whose mean droplet size is generally less than or equal to about 0.15 μm. The size of the microemulsion droplets may be measured by dynamic light scattering (DLS), for example as described below. The apparatus used consists, for example, of a Spectra-Physics 2020 laser, a Brookhaven 2030 correlator and the associated computer-based equipment. If the sample is concentrated, it may be diluted in deionized water and filtered through a 0.22 μm filter to have a final concentration of 2% by weight. The diameter obtained is an apparent diameter. The measurements are taken at angles of 90° and 135°. For the size measurements, besides the standard analysis with cumulents, three exploitations of the autocorrelation function are used (exponential sampling or EXPSAM described by Prof. Pike, the “Non Negatively Constrained Least Squares” or NNLS method, and the CONTIN method described by Prof. Provencher), which each give a size distribution weighted by the scattered intensity, rather than by the mass or the number. The refractive index and the viscosity of the water are taken into account.

According to one embodiment, the microemulsion is transparent. The microemulsion may have, for example, a transmittance of at least 90% and preferably of at least 95% at a wavelength of 600 nm, for example measured using a Lambda 40 UV-visible spectrometer.

According to another embodiment, the emulsion is an emulsion whose mean droplet size is greater than or equal to 0.15 μm, for example greater than 0.5 μm, or 1 μm, or 2 μm, or 10 μm, or 20 μm, and preferably less than 100 μm. The droplet size may be measured by optical microscopy and/or laser granulometry (Horiba LA-910 laser scattering analyzer).

In certain embodiments, the dibasic ester blend comprises:

a diester of formula I:

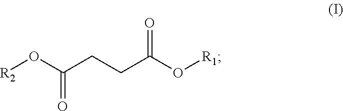

a diester of formula II:

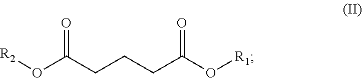

and

a diester of formula III:

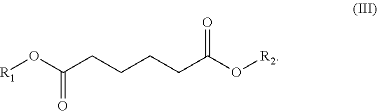

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl or octyl. In such embodiments, the blend typically comprises (by weight of the blend) (i) about 15% to about 35% of the diester of formula I, (ii) about 55% to about 70% of the diester of formula II, and (iii) about 7% to about 20% of the diester of formula III, and more typically, (i) about 20% to about 28% of the diester of formula I, (ii) about 59% to about 67% of the diester of formula II, and (iii) about 9% to about 17% of the diester of formula III. The blend is generally characterized by a flash point of 98° C., a vapor pressure at 20° C. of less than about 10 Pa, and a distillation temperature range of about 200-300° C. Mention may also be made of Rhodiasolv® RPDE (Rhodia Inc., Cranbury, N.J.), Rhodiasolv® DIB (Rhodia Inc., Cranbury, N.J.) and Rhodiasolv® DEE (Rhodia Inc., Cranbury, N.J.).

In certain other embodiments, the dibasic ester blend comprises:

a diester of the formula IV:

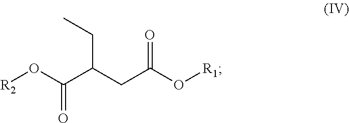

a diester of the formula V:

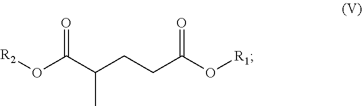

and, optionally,

a diester of the formula VI:

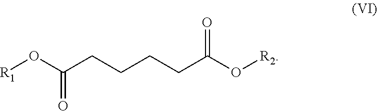

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl, or octyl. In such embodiments, the blend typically comprises (by weight of the blend) (i) from about 5% to about 30% of the diester of formula IV, (ii) from about 70% to about 95% of the diester of formula V, and (iii) from about 0% to about 10% of the diester of formula VI. More typically, the blend typically comprises (by weight of the blend): (i) from about 6% to about 12% of the diester of formula IV, (ii) from about 86% to about 92% of the diester of formula V, and (iii) from about 0.5% to about 4% of the diester of formula VI.

Most typically, the blend comprises (by weight of the blend): (i) about 9% of the diester of formula IV, (ii) about 89% of the diester of formula V, and (iii) about 1% of the diester of formula VI. The blend is generally characterized by a flash point of 98° C., a vapor pressure at 20° C. of less than about 10 Pa, and a distillation temperature range of about 200-275° C. Mention may be made of Rhodiasolv® IRIS and Rhodiasolv® DEE/M, manufactured by Rhodia Inc. (manufactured by Rhodia Inc., Cranbury, N.J.)

In one embodiment, water can include but is not limited to tap water, filtered water, bottled water, spring water, distilled water, deionized water, and/or industrial soft water.

In another embodiment, the solvent can include organic solvents, including but not limited to aliphatic or acyclic hydrocarbons solvents, halogenated solvents, aromatic hydrocarbon solvents, glycol ether, a cyclic terpene, unsaturated hydrocarbon solvents, halocarbon solvents, polyols, ethers, esters of a glycol ether, alcohols including short chain alcohols, ketones or mixtures thereof.

In one embodiment, additional surfactants may be utilized in the present invention. Surfactants that are useful for preparing the microemulsion of the present invention can be one or more anionic surfactants, cationic surfactants, non-ionic surfactants, zwitterionic surfactants, amphoteric surfactants.

Typically nonionic surfactants are utilized, which include but are not limited to polyalkoxylated surfactants, for example chosen from alkoxylated alcohols, alkoxylated fatty alcohols, alkoxylated triglycerides, alkoxylated fatty acids, alkoxylated sorbitan esters, alkoxylated fatty amines, alkoxylated bis(1-phenylethyl)phenols, alkoxylated tris(1-phenylethyl)phenols and alkoxylated alkylphenols, in which the number of alkoxy and more particularly oxyethylene and/or oxypropylene units is such that the HLB value is greater than or equal to 10. More typically, the nonionic surfactant can be selected from the group consisting of ethylene oxide/propylene oxide copolymers, terpene alkoxylates, alcohol ethoxylates, alkyl phenol ethoxylates and combinations thereof.

In one embodiment, the alcohol ethoxylates used in connection with the present invention have the formula:

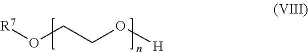

Typically, R⁷ is a hydrogen or a hydrocarbon chain containing about 5 to about 25 carbon atoms, more typically from about 7 to about 14 carbon atoms, most typically, from about 8 to about 13 carbon atoms, and may be branched or straight-chained and saturated or unsaturated and is selected from the group consisting of hydrogen, alkyl, alkoxy, aryl, alkaryl, alkylarylalkyl and arylalkyl. Typically, “n” is an integer from about 1 to about 30, more typically an integer from 2 to about 20, and most typically an integer from about 3 to about 12.

In an alternative embodiment, the alcohol ethoxylate is sold under the trade name Rhodasurf 91-6 (manufactured by Rhodia Inc., Cranbury, N.J.).

In yet another embodiment, surfactants used in the present invention are non-ionic surfactants including but not limited to: polyoxyalkylenated C₆-C₂₄ aliphatic alcohols comprising from 2 to 50 oxyalkylene (oxyethylene and/or oxypropylene) units, in particular of those with 12 (mean) carbon atoms or with 18 (mean) carbon atoms; mention may be made of Antarox B12DF, Antarox FM33, Antarox FM63 and Antarox V74, Rhodasurf ID 060, Rhodasurf ID 070 and Rhodasurf LA 42 from (Rhodia Inc., Cranbury, N.J.), as well as polyoxyalkylenated C₈-C₂₂ aliphatic alcohols containing from 1 to 25 oxyalkylene (oxyethylene or oxypropylene) units.

In a further embodiment, the surfactant comprises a terpene or a terpene alkoxylate. Terpene alkoxylates are terpene-based surfactants derived from a renewable raw materials such as α-pinene and β-pinene, and have a C-9 bicyclic alkyl hydrophobe and polyoxy alkylene units in an block distribution or intermixed in random or tapered distribution along the hydrophilic chain. The terpene alkoxylate surfactants are described in the U.S. Patent Application Publication No. 2006/0135683 to Adam al., Jun. 22, 2006, is incorporated herein by reference.

Typical terpene alkoxylates are Nopol alkoxylate surfactants and have the general formula:

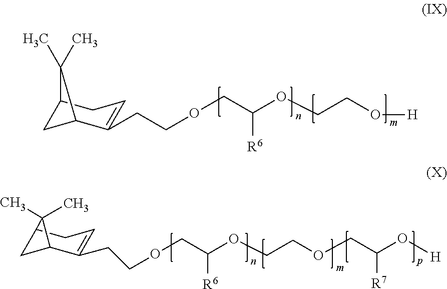

where R⁶ and R⁷ are, individually, hydrogen, CH₃, or C₂H₅; “n” is from about 1 to about 30; “m” is from about 0 to about 20; and “p” is from about 0 to 20. The “n”, “m” and/or “p” units may be of block distribution or intermixed in random or tapered distribution along the chain.

In another embodiment, R⁶ is CH₃; “n” is from about 20 to about 25; “m” is from about 5 to about 10. In yet another embodiment, R⁶ and R⁷ are individually CH₃; “n” is from about 1 to about 8; “m” is from about 2 to about 14; and “p” is from about 10 to about 20. Mention can be made of Rhodoclean® HP (a terpene EO/PO)(manufactured by Rhodia Inc., Cranbury, N.J.) and Rhodoclean® MSC (a terpene EO/PO)(manufactured by Rhodia Inc., Cranbury, N.J.).

In one embodiment, the present invention is a stable microemulsion: comprising:

(a) from about 1% to about 60%, by weight of the microemulsion, a blend of dibasic esters comprising:

(i) a first dibasic ester of formula:

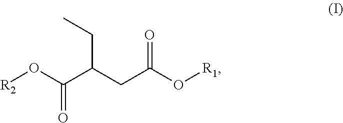

(ii) a second dibasic ester of formula:

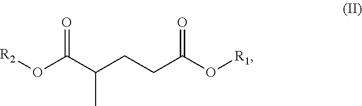

and

(iii) a third dibasic ester of formula:

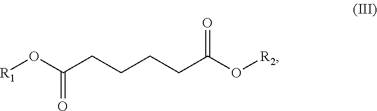

wherein R₁ and R₂ are each, independently, a hydrocarbon group having from about 1 to about 9 carbon atoms; (b) from about 0% to about 65%, by weight of the cleaning composition, a terpene alkoxylate; (c) from about 0.1% to about 20%, by weight of the cleaning composition, an alcohol alkoxylate; and (d) water. Mention may also be made of Rhodiasolv® Infinity (Rhodia Inc., Cranbury, N.J.)

In this particular embodiment, as well as other embodiments of the present invention, the microemulsion or “active” can be diluted in water to a great extent yet still remain a stable microemulsion. In some embodiments, the active is diluted in water to about 50% active by weight of total mixture (i.e., water-active mixture). In another embodiment, the active is diluted in water to about 40% active by weight of total mixture. In another embodiment, the active is diluted in water to about 35% active by weight of total mixture. In another embodiment, the active is diluted in water to about 30% active by weight of total mixture. In another embodiment, the active is diluted in water to about 20% active by weight of total mixture. In another embodiment, the active is diluted in water to about 15% active by weight of total mixture. In another embodiment, the active is diluted in water to about 10% or less active by weight of total mixture. In another embodiment, the active is diluted in water to about 8% active by weight of total mixture. In another embodiment, the active is diluted in water to about 6% active by weight of total mixture. In another embodiment, the active is diluted in water to about 5% active by weight of total mixture. In another embodiment, the active is diluted in water to about 4% or less active by weight of total mixture. In another embodiment, the active is diluted in water to about 3% or less active by weight of total mixture. In another embodiment, the active is diluted in water to about 2% or less active by weight of total mixture. In another embodiment, the active is diluted in water to about 1% or less active by weight of total mixture. In another embodiment, the active is diluted in water to about 0.5% or 0.1% or less active by weight of total mixture.

In a further or alternative embodiment, additional components or additives may be added to the cleaning composition of the present invention. The additional components include, but are not limited to, delaminates, buffering and/or pH control agents, fragrances, perfumes, defoamers, dyes, whiteners, brighteners, solubilizing materials, stabilizers, thickeners, corrosion inhibitors, lotions and/or mineral oils, enzymes, cloud point modifiers, preservatives, ion exchangers, chelating agents, sudsing control agents, soil removal agents, softening agents, opacifiers, inert diluents, graying inhibitors, stabilizers, polymers and the like.

Typically, additional components comprise one or more delaminates. Delaminates can be certain terpene-based derivatives that can include, but are not limited to, pinene and pinene derivatives, d-limonene, dipentene and α-pinene.

The buffering and pH control agents include for example, organic acids, mineral acids, as well as alkali metal and alkaline earth salts of silicate, metasilicate, polysilicate, borate, carbonate, carbamate, phosphate, polyphosphate, pyrophosphates, triphosphates, ammonia, hydroxide, monoethanolamine, monopropanolamine, diethanolamine, dipropanolamine, triethanolamine, and/or 2-amino-2-methylpropanol.

More specifically, the buffering agent can be a detergent or a low molecular weight, organic or inorganic material used for maintaining the desired pH. The buffer can be alkaline, acidic or neutral, including but not limited to 2-amino-2-methyl-propanol; 2-amino-2-methyl-1,3-propanol; disodium glutamate; methyl diethanolamide; N,N-bis(2-hydroxyethyl)glycine; tris(hydroxymethyl)methyl glycine; ammonium carbamate; citric acid; acetic acid; ammonia; alkali metal carbonates; and/or alkali metal phosphates.

In still another embodiment, thickeners, when used, include, but are not limited to, cassia gum, tara gum, xanthan gum, locust beam gum, carrageenan gum, gum karaya, gum arabic, hyaluronic acids, succinoglycan, pectin, crystalline polysaccharides, clay, silicas and fumed silicas, branched polysaccharide, calcium carbonate, aluminum oxide, alginates, guar gum, hydroxypropyl guar gum, carboxymethyl guar gum, carboxymethylhydroxypropyl guar gum, and other modified guar gums, hydroxycelluloses, hydroxyalkyl cellulose, including hydroxyethyl cellulose, carboxymethylhydroxyethyl cellulose, hydroxypropyl cellulose, carboxymethylcellulose and/or other modified celluloses. In a further embodiment, the whiteners include, but are not limited to, percarbonates, peracids, perborates, chlorine-generating substances hydrogen peroxide, and/or hydrogen peroxide-based compounds. In another embodiment, the polymer is generally a water soluble or dispersable polymer having a weight average molecular weight of generally below 2,000,000.

Since dibasic esters are subject to hydrolysis under certain conditions, it is understood that the blend of dibasic esters can contain a minute amount of alcohol, typically a low molecular weight alcohol such as ethanol, in concentrations of about 2% to about 0.2%.

A generally contemplated composition of the present invention, in one embodiment, comprises (based on the total weight of the composition) (a) from about 1% to about 60% by weight a blend of dibasic esters and (b) from about 1% to about 65% by weight one or more surfactants. The composition may optionally contain water or a solvent in varying amounts, depending on the desired concentration. For example, it may be desirable to have the composition of the present invention as a concentrated composition for shipping, transportation purposes as well as for other cost savings. It may also be desirable to have the present invention in fully diluted form.

In either concentrated or diluted form, the composition of the present invention is hydrolytically stable, typically up to 6 months or greater, more typically up to 12 months or greater for the diluted form and longer in the concentrated form. The formulations of the present invention, which contain the dibasic ester blends, typically, MGN blends, have hydrolysis stability, where hydrolysis/decomposition typically produces the acid form of the ester and methanol. The methanol concentration of the formulation comprising the described dibasic ester blend was monitored and shown to generally be stable, typically less than 300 ppm (parts per million), more typically less than or about 250 ppm, typically at or less than about 210 ppm. (When prior art ester-based cleaning solutions sit in an aqueous solution, the esters typically begin to decompose. The decomposing ester produces undesirable and potentially hazardous byproducts. Furthermore, as the ester decomposes, the amount of ester, which is the active ingredient in the cleaning solution, is decreasing.)

In one embodiment, the cleaning composition further comprises about 0% to about 15% by weight d-limonene. In another embodiment, the cleaning composition further comprises about 0.5% to about 12% by weight d-limonene. In another embodiment, the cleaning composition further comprises about 1% to about 10% by weight d-limonene. The cleaning composition of the present invention can be used in a variety of consumer and/or industrial applications.

In another aspect, the present invention is a cleaning composition comprising: from about 1% to about 60% by weight a blend of dibasic esters; from about 0.1% to about 50% by weight one or more surfactants; and, optionally, water; more typically, from about 5% to about 40% by weight a blend of dibasic esters; (b) from about 5% to about 40% by weight one or more surfactants, typically, one or more nonionic surfactants; and, optionally, (c) water. In another embodiment, the cleaning composition further comprises about 1% to about 12% by weight a pinene or derivative thereof, typically, d-limonene. Optionally, additives such as fragrances and solubilizers, pH adjusting agents, whiteners, delaminates, opacifying agent, anti-corrosion agents, anti-foaming agents, coloring agents, stabilizers and thickeners can be added. The cleaning composition of the present invention is typically in form of a microemulsion and provided as a liquid or spray formulation for use, depending upon the application. The cleaning composition of the present invention is typically in form of a microemulsion. The cleaning composition can also be provided as a liquid or spray formulation for use, depending upon the application.

The present invention in one embodiment, is a method for removing oil, oil-based stains, and also includes other stains such as hydrophobic stains for example, pencil, crayon, highlighter, ketchup, permanent marker, mustard, ink, washable marker, lipstick, and hydrophobic stains in general, ink (typically, printing ink), organic stains on clothes, resin, tar-resin, graffiti, stains on painted surfaces or plastic or metal substrates, from skin or hair, paint from a surface, or as a degreasing composition.

In one exemplary embodiment, present invention involves using the cleaning composition of the present invention as an oil dispersant. As used as an oil dispersant, the present invention can break oil from a spill, slick or leak, typically at or proximal to the water surface, is capable of enhancing degradation of the oil and in addition can improve light penetration into the water. The present invention can also be used in surface washing of objects or substrates that is at least partially coated with oil. Objects that can be cleaned are sand, rocks and general objects located on a shoreline that may come in contact with an oil spill, slick or leak. The present invention can also clean other objects such as wildlife, birds, plants, mammals. The present invention can also be used in surface collecting.

In another embodiment, the present invention can be utilized to clean oil, grease and the like from equipment. The present invention can also be used to clean buildings or other work surfaces. The present invention can also be used to clean equipment utilized in fracturing fluid, well cutting and mud reversal. Generally, the present invention can be utilized to clean devices and composition utilized in oil well servicing or drilling. Other equipment include but is not limited to: mining truck (e.g., for tar), asphalt trucks, vessels, boats, transit tanks, storage tanks, mixing tanks, reactors, buildings, siding, floors, concrete, bricks, wood,

The composition may optionally contain water, typically from about 1% to about 85% by weight of the composition, or a solvent in varying amounts, depending on the desired concentration. Methods for cleaning a textile are also contemplated, which includes obtaining or preparing the textile cleaning composition, contacting the cleaning composition onto a surface or material to be cleaned, and, optionally, removing the used cleaning composition from the surface or material.

Experiments

Light Crude Oil

To test the dispersibility of oil in sea water with the help of dispersant, light crude oil was dispersed in sea water with the help of dispersants. Test dispersants are Rhodiasolv Infinity at 100% and 1% active, and 80% Infinity with 20% Rhodiasolv DIB. It was compared against a benchmark dioctyl sulfosuccinate DOS at 100% active.

A 50-mL sea water was mixed with 5 mL crude oil mixed with dispersant Rhodiasolv Infinity (dispersant to oil ratio=1:10 v/v). The mixture was agitated for 5 mins and let stand for another 5 mins. It was observed that at 1% active Rhodiasolv Infinity, the oil dispersed at equivalent level as the benchmark DOS in terms of oil separation on surface of water and color intensity of the bulk water. At 100% Rhodiasolv Infinity and at 80/20% of Rhodiasolv Infinity/Rhodiasolv DIB, the oil was much better dispersed as a darker color (i.e., color intensity) in the bulk water and less oil separation on the surface was observed.

Medium Density Crude Oil

To test the dispersibility of oil in sea water with the help of dispersant, medium density crude oil was dispersed in sea water with the help of dispersants. Test dispersants are Rhodiasolv Infinity at 5% active, and 80% Infinity with 20% Rhodiasolv DIB. It was compared against a benchmark dioctyl sulfosuccinate DOS at 50% active. A 50-mL sea water was mixed with 5 mL crude oil mixed with dispersant Rhodiasolv Infinity (dispersant to oil ratio=1:10 v/v). The mixture was agitated for 5 minutes and let stand for another 5 minutes. We observed that at 5% active Rhodiasolv Infinity, the oil dispersed at equivalent level as the benchmark DOS at 50% in terms of oil separation on surface of water and color intensity of the bulk water.

Application on Sand as a Surface Washing Agent

Against dioctyl sulfosuccinate DOS—To test the surface washing ability, light crude oil that was applied on sand was washed with test surface washing agent (“SWA”) Rhodiasolv infinity. Test SWA is Rhodiasolv Infinity at 100% active. It was compared against a benchmark dioctyl sulfosuccinate DOS at 100% active. A 2-mL crude oil sample was applied on 40 grams of sand that was pre-wet with sea water. After 5 mins, 4-mL of Rhodiasolv Infinity was then applied onto the sand (SWA to oil ratio=2:1v/v) and the sand is then rinsed with sea water. It was observed that Rhodiasolv Infinity significantly washed out oil from the sand. Much less oil was left on the sand and the rinse water turned yellow as an indication of washed oil from the sand (i.e., oil mixed in the rinse water). In contrast, the benchmark DOS did not wash most of the oil from the sand and the wash water stayed colorless, as an indication of the amount of oil washed from the sand. It was concluded that Rhodiasolv Infinity outperform DOS as a surface washing agent.

Against Simple Green®/light crude oil—To test the surface washing ability, light crude oil that was applied on sand was washed with test surface washing agent (SWA) Rhodiasolv infinity. Test SWA is Rhodiasolv Infinity at 100% active. It was compared against benchmark Simple Green® at 1% active. A 1-mL light crude oil was applied on 20 g sand that was pre-wet with sea water. After 24 hours of application (weathering), 4-mL of Rhodiasolv Infinity was then applied onto the sand (SWA to oil ratio=2:1v/v) and the sand is then rinse with sea water. It was observed that Rhodiasolv Infinity clearly washed out the oil from the sand. Much less oil was left on the sand and the rinse water has turned slightly yellow as an indication of washed oil from the sand. Similarly, it was observed that the benchmark Simple Green washed out the oil at about an equivalent amount.

Against Simple Green®/medium density crude oil—To test the surface washing ability, medium density crude oil that was applied on sand was washed with test surface washing agent (SWA) Rhodiasolv infinity. Test SWA is Rhodiasolv Infinity at 100% active. It was compared against benchmark Simple Green® at 1% active. A 1-mL medium density crude oil was applied on 20 g sand that was pre-wet with sea water. After 24 hours of application (weathering), 4-mL of Rhodiasolv Infinity was then applied onto the sand (SWA to oil ratio=2:1v/v) and the sand is then rinse with sea water. It was observed that Rhodiasolv Infinity clearly washed out the medium density crude oil from the sand. Much less oil was left on the sand and the rinse water has turned slightly yellow as an indication of washed oil from the sand. Similarly, it was observed that the benchmark Simple Green washed out the oil at about an equivalent amount.

Application on Pebbles as a Surface Washing Agent

Against Simple Green®/medium density crude oil—To test the surface washing ability, medium density crude oil that was applied on pebbles was washed with test surface washing agent (SWA) Rhodiasolv infinity. Test SWA is Rhodiasolv Infinity at 100% active. It was compared against benchmark Simple Green® at 1% active. A 1-mL medium density crude oil was applied on pebbles that were pre-wet with sea water. After 24 hours of application (weathering), 4-mL of Rhodiasolv Infinity was then applied onto the pebbles (SWA to oil ratio=2:1v/v) and the pebbles were then rinse with sea water. It was observed that Rhodiasolv Infinity clearly washed out the medium density crude oil from the pebbles. Much less oil was left on the pebbles and the rinse water has turned slightly yellow as an indication of washed oil from the pebbles. Similarly, it was observed that the benchmark Simple Green washed out the oil at about an equivalent amount.

Application on Feathers as a Surface Washing Agent

Against dioctyl sulfosuccinate DOS—To test the surface washing ability, light crude oil applied on feathers was washed with test surface washing agent (“SWA”) Rhodiasolv infinity. Test SWA is Rhodiasolv Infinity at 100% active. It was compared against a benchmark dioctyl sulfosuccinate DOS at 100% active. A 2-mL crude oil sample was applied on 2 test feathers that were pre-wet with sea water. After 5 mins, 4-mL of Rhodiasolv Infinity was then applied onto the first test feather (SWA to oil ratio=2:1v/v) and the feather was then rinsed with sea water. It was observed that Rhodiasolv Infinity significantly washed out oil from the feather. Much less oil was left on the feather and the rinse water turned yellow as an indication of washed oil from the feather. In contrast, the benchmark DOS did not wash most of the oil from the second test feather and the wash water stayed colorless, as an indication of the amount of oil washed from the sand. It was concluded that Rhodiasolv Infinity outperformed DOS as a surface washing agent on feathers.

Rhodiasolv Infinity Effect on Oil-Base Mud (OBM)

Mud inversion and heavy oil dispersion are examples that the low surface tension (ST) microemulsion, e.g., Rhodiasolv Infinity, has an effect on these systems. The mud was dispersed and inverted with 1% Rhodiasolv Infinity. A heavy oil was dispersed by 100% Rhodiasolv Infinity.

Demulsifier testing was also performed. It was observed that Rhodiasolv Infinity was able to break water-in-oil emulsions of crude oil. Rhodiasolv Infinity can be applied to oil removal applications as part of a clean-up effort.

As potential cleaners for inland contamination or maintenance cleaning, surfaces can be chosen—trucks, reaction vessels, transit equipments, building or other infrastructures.

The present invention, therefore, is well adapted to carry out the objects and attain the ends and advantages mentioned, as well as others inherent therein. While the invention has been depicted and described and is defined by reference to particular preferred embodiments of the invention, such embodiments do not imply a limitation on the invention, and no such limitation is to be inferred. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

1. A microemulsion composition for dispersing oil at or near the surface of water comprising:
(a) from about 1% to about 60%, by weight of the microemulsion, a blend of dibasic esters comprising:
(i) a first dibasic ester of formula: 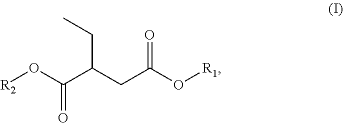
(ii) a second dibasic ester of formula: 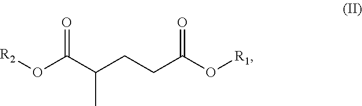
and, optionally,
(iii) a third dibasic ester of formula: 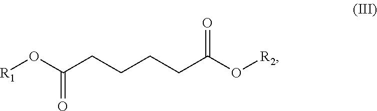
wherein R₁ and R₂ are each, independently, a C₁-C₉ hydrocarbon group;
(b) from about 0.1% to about 65%, by weight of the cleaning composition, a terpene alkoxylate; and
(c) water.

2. The microemulsion composition of claim 1 further comprising an alcohol alkoxylate.

3. The microemulsion composition of claim 1 whereby the microemulsion composition is capable of removing crude oil from a surface.

4. The microemulsion composition of claim 1 further comprising at least one surfactant selected from the group consisting of an anionic surfactant, a cationic surfactant, an amphoteric surfactant, a zwitterionic surfactant, a nonionic surfactant and any combination thereof.

5. The microemulsion of claim 1 wherein the microemulsion remains stable upon dilution with water of up to about 99% by total weight of the mixture.

6. The microemulsion composition of claim 1 wherein the blend of dibasic esters further comprises dialkyl adipate, dialkyl methlglutarate and dialkyl ethylsuccinate.

7. The microemulsion composition of claim 1 wherein the blend of dibasic esters is derived from one or more by-production of polyamide.

8. The microemulsion composition of claim 1 further comprising a co-solvent selected from the group consisting of saturated hydrocarbons, glycol ethers, fatty acid methyl esters, aliphatic hydrocarbons, acyclic hydrocarbons, halogenated solvents, aromatic hydrocarbons, cyclic terpenes, unsaturated hydrocarbon, halocarbon, polyols, ethers, esters of a glycol ether, alcohols, water, ketones, and any combination thereof.

9. The microemulsion composition of claim 1 further comprising one or more additives selected from the group consisting of delaminates, buffering agents, fragrances, perfumes, defoamers, dyes, whiteners, brighteners, solubilizing materials, stabilizers, thickeners, corrosion inhibitors, lotions, mineral oils, enzymes, cloud point modifiers, particles, preservatives, ion exchangers, chelating agents, sudsing control agents, soil removal agents, softening agents, opacifiers, inert diluents, graying inhibitors, stabilizers, polymers and any combination thereof.

10. The microemulsion composition of claim 1 wherein the blend of dibasic esters is characterized by vapor pressure of less than about 10 Pa.

11. The microemulsion composition of claim 8 wherein the co-solvent is the aliphatic hydrocarbon, the aliphatic hydrocarbon having a flash point of greater than 60° C.

12. The microemulsion composition of claim 4 wherein:
(i) the alcohol alkoxylate comprises from about 5% to about 55%, by weight of the composition; and
(ii) the terpene alkoxylate comprises from about 0.1% to about 25%, by weight of the composition.

13. The microemulsion composition of claim 1 wherein the terpene alkoxylate is of formula: 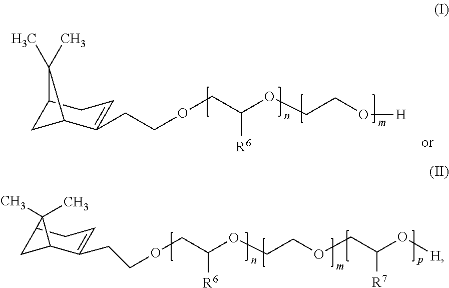
wherein R⁶ and R⁷ are, individually, hydrogen, CH₃, or C₂H₅; “n” is an integer from about 1 to about 30; and “m” is an integer from 0 to about 20; and “p” is an integer from 0 to about 20.

14. The microemulsion composition of claim 2 wherein the alcohol alkoxylate is of formula: 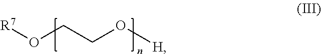
wherein R⁷ is a hydrogen or a hydrocarbon chain containing about 5 to about 25 carbon atoms, “n” is an integer of from about 1 to about 30.

15. The microemulsion composition of claim 14 wherein “n” is an integer of from about 3 to about 12.

16. A method of dispersing oil at or near the surface of water comprising:
providing the microemulsion composition of claim 1; and
contacting the microemulsion composition with water having crude oil at or on the surface of the water.

17. The method of claim 16 further comprising the step of diluting the microemulsion from claim 1 to about 1% to about 50% by weight of the resulting mixture.

18. A method of cleaning a surface in contact with crude oil comprising:
providing the cleaning composition of claim 1;
contacting the cleaning composition with a surface having crude oil on it, and
removing the used cleaning composition from the cleaned surface.

19. A microemulsion composition for dispersing oil at or near the surface of water comprising:
(a) from about 1% to about 60%, by weight of the microemulsion, a blend of dibasic esters comprising:
(a.i) a dibasic ester of formula I: 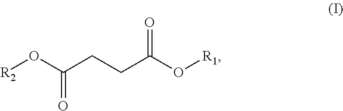
wherein R₁ and R₂ are each, independently, a butyl, an isobutyl, or an n-butyl hydrocarbon group,
(a.ii) a dibasic ester of formula II: 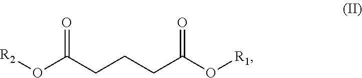
wherein R₁ and R₂ are each, independently, a butyl, an isobutyl, or an n-butyl hydrocarbon group,
(a.iii) a dibasic ester of formula III: 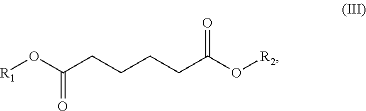
wherein R₁ and R₂ are each, independently, a butyl, an isobutyl, or an n-butyl hydrocarbon group,
(a.iv) a dibasic ester of formula IV: 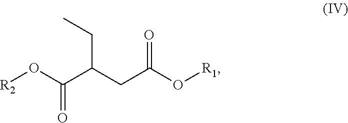
wherein R₁ and R₂ are each, independently, a C₁-C₉ hydrocarbon group,
(a.v) a dibasic ester of formula V: 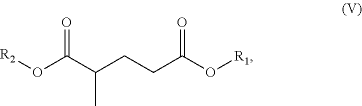
wherein R₁ and R₂ are each, independently, a C₁-C₉ hydrocarbon group, and, optionally,
(a.vi) a dibasic ester of formula VI: 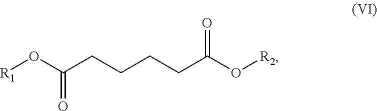
wherein R₁ and R₂ are each, independently, a C₁-C₉ hydrocarbon group;
(b) from about 1% to about 65%, by weight of the composition, a terpene alkoxylate; and
(c) water.

20. The microemulsion composition of claim 19 further comprising an alcohol alkoxylate.

21. The microemulsion composition of claim 19 whereby the microemulsion composition is capable of removing crude oil from a surface.

22. The microemulsion composition of claim 19 further comprising at least one surfactant selected from the group consisting of an anionic surfactant, a cationic surfactant, an amphoteric surfactant, a zwitterionic surfactant, a nonionic surfactant and any combination thereof.

23. The microemulsion composition of claim 20 wherein:
(i) the alcohol alkoxylate comprises from about 5% to about 55%, by weight of the composition; and
(ii) the terpene alkoxylate comprises from about 0.1% to about 25%, by weight of the composition.
